(19) United States
(12) Patent Application Publication
(10) Pub. No.: US 2007/0263016 A1
(43) Pub. Date: Nov. 15, 2007

(54) Digital drive architecture for flat panel displays

(76) Inventors: W. Edward Naugler JR., Cedar Park, TX (US); Michael Frank, Sunnyvale, CA (US); Chester Floyd Bassetti, Reno, NV (US)

Correspondence Address: HOWREY LLP, C/O IP DOCKETING DEPARTMENT, 2941 FAIRVIEW PARK DRIVE, SUITE 200, FALLS CHURCH, VA, 22042-2924, US

(21) Appl. No.: 11/440,543

(22) Filed: May 24, 2006

Related U.S. Application Data
(60) Provisional application No. 60/686,830, filed on May 25, 2005.

(51) Int. Cl. G09G 5/10

(52) U.S. Cl. 345/690

(57) ABSTRACT

This present invention describes a new digital drive concept for flat panel displays where an all-digital drive is used to write data to pixels, which establish the gray scale for each pixel. In addition the invention integrates the all-digital drive with an optical sensor feedback circuit in the pixel without having to add an extra data line for the pixel sensor. Also discussed is a novel unique pulse timing system, where the positioning of the pulse in time has 12 bit accuracy using 8 bit gray scale data and a phase delay system (delay locked loop, DLL).

### RELATED APPLICATIONS

The present application claims priority from U.S. Provisional Patent Application No. 60/686,830, filed on May 25 2005, which is incorporated herein by reference. The present application is also related to the following patent applications, assigned to the Nuelight Corporation, the assignee of the present application: U.S. application Ser. No. 11/016,372 entitled Active Matrix Display and Pixel Architecture for Feedback Stabilized Flat Panel Display; U.S. application Ser. No. 11/015,638 entitled Feedback Control System and Method for Operating a High-Performance Stabilized Active-Matrix Emissive Display; U.S. application Ser. No. 11/016,357 entitled High-Performance Emissive Device for Computers, Information Appliances, and Entertainment Systems; U.S. application Ser. No. 11/016,137 entitled Method for Operating and Individually Controlling the Luminance of Each Pixel in an Emissive Active Matrix Display Device; and U.S. application Ser. No. 11/016,686 entitled Device and Method for Operating a Self-Calibrating Emissive Pixel. These patent applications are incorporated herein by reference.

### FIELD OF INVENTION

The present invention relates to flat panel displays. Particularly, the present invention relates to a display control system for performing display/drive control of a flat panel display such as a LCD (Liquid Crystal Display), OLED (Organic LED Display), or any other display utilizing matrix addressable pixels.

### BACKGROUND OF THE INVENTION

In the current state of the art, flat panel displays using an X-Y-addressable matrix of pixels are generally controlled by sequentially accessing rows of pixels and driving a control signal down each column. The pixel at the intersection of the row and the column is selected and uses the control signal to determine the brightness for the duration of the next frame. The control signal is an analog voltage, which is loaded into a storage capacitor in the pixel through a TFT (thin film transistor) switch also located in the pixel.

In the case of an LCD, the storage capacitor is in parallel with the liquid crystal (LC) cell and is used to augment the capacitance of the LC cell. The TFT switch locks the voltage on the storage capacitor and the LC cell for the duration of the frame time, which in a typical system of 60 frames per second (fps) is 16.7 ms (milliseconds). The value of the voltage determines the degree of untwisting of the LC molecules, and thus, the amount of ε-field (electric field) rotation of the polarized light passing though the LC cell.

In the case of emissive type displays, for example, OLED displays, the downloaded voltage is applied to the gate of a pixel driving TFT. The TFT applies either an ac (alternating current) voltage to the emitting material as in the electroluminescent type materials, or a DC (direct current) current as in the new organic light emitting diode (OLED) materials now being developed in laboratories around the world. The addition of the pixel driving TFTs in the OLED displays causes several manufacturing problems including process uniformity and circuit ageing that are absent in the LCD manufacturing process. Also associated with the OLED displays is the problem of differential ageing of the different OLED colors, such that the color balance is not maintained.

Typically, image data is processed digitally. In practice, serial analog image signals are converted to digital signals processed through various functions including memory storage, correctional logic and gamma tables. The digital signals are then converted back to analog signals by digital to analog converters (DACs) in the gamma function, or at the head of every column of the display to be down loaded to individual pixel drivers. DACs are expensive and use significant power. It would be desirable to eliminate the DACs and have a pure digital drive system for any display where the image information downloaded to the pixels is an analog voltage.

### SUMMARY OF THE INVENTION

It is an object of the present invention to provide a flat panel display control system, which utilizes only digital signals in the column drivers. Essentially, the pixel itself becomes the digital to analog converter (DAC). This is accomplished by supplying a global ramp signal timed with the row address timing. During the row address, the data TFT (thin film transistor) is turned on and passes the ramp signal to the LCD cell or the emissive pixel driver TFT. The timing of the data TFT is controlled by a pulse generator that determines the exact time for a pulse window (called the aperture) to occur during the global voltage ramp to produce the required voltage across the LCD cell or on the gate of the current driver TFT for emissive pixels. Also included is the integration of the invention with an emissive feedback system for controlling circuit and material aging problems.

The benefits of the present invention include easy circuit integration and thus lower cost of design, less area used by driver integrated chips (ICs) and thus lower cost, and power savings due to the elimination of D to A converters. Also, the standard 0.18 micron process can be used for 12 bit accuracy provided by the present invention. The present invention also provides more bits at lower cost, 12 bit logic with low frequency clocks, and is easily scalable to expand the size of the display.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention. The objects and advantages of the present invention will be apparent upon consideration of the following detailed description, taken in conjunction with these drawings, in which like reference characters refer to like parts throughout, and in which:

FIG. 1 is a block diagram of an exemplary LCD display system according to the present invention;

FIG. 2 is a graph showing an exemplary ramp signal;

FIG. 3 is a block diagram of an exemplary pulse shaper of the present invention;

FIG. 4 is a schematic of an exemplary LCD pixel cell in which the present invention can be implemented;

FIG. 5 illustrates the pulse position method using the voltage ramp of the present invention;

FIG. 6 is a delay locked loop block diagram showing tapped phase positions;

FIG. 7 is a schematic of an exemplary emissive pixel of the present invention;

FIG. 8A is a schematic of an exemplary emissive display system of the present invention having a feedback system; and

FIG. 8B illustrates an exemplary timing diagram for the operation of the emissive display system illustrated in FIG. 8A.

### DETAILED DESCRIPTION OF THE INVENTION

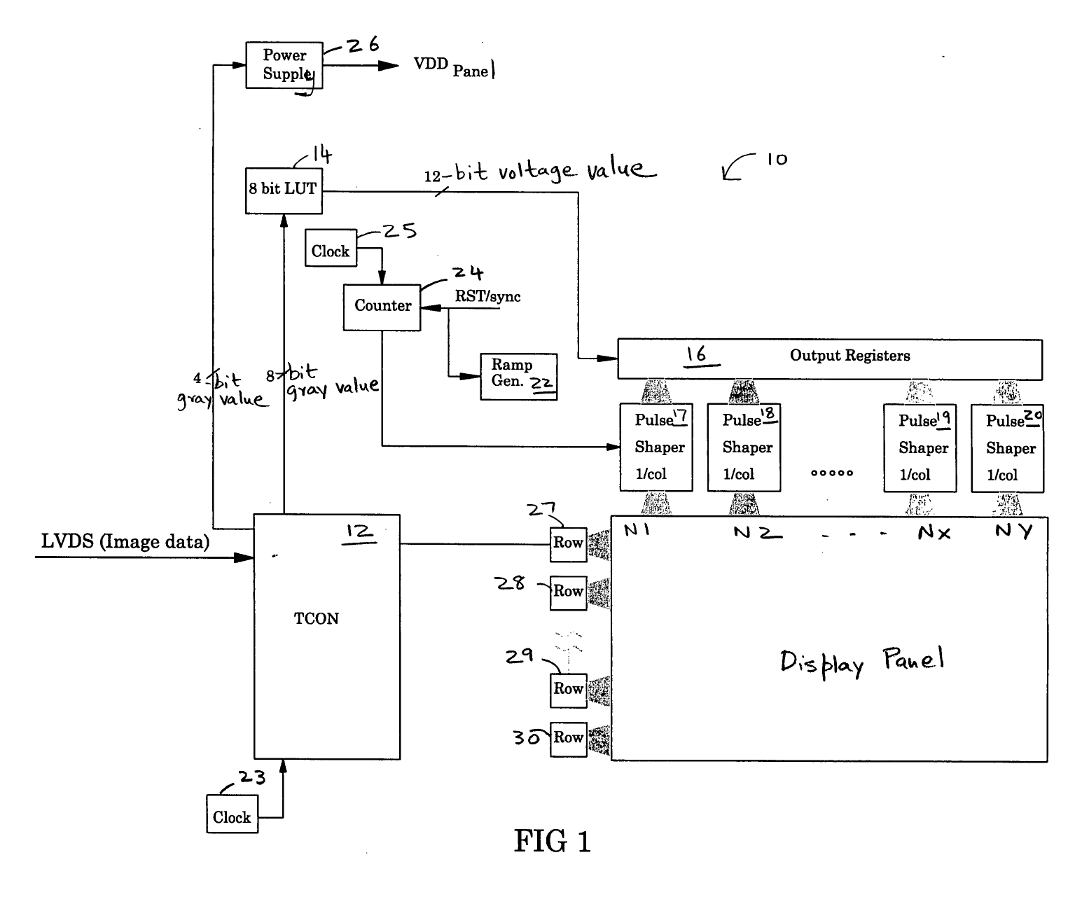

FIG. 1 is a block diagram of a display system 10 according to the present invention. This embodiment relates to a liquid crystal display. In this embodiment, the image data (low voltage differential signal (LVDS) or reduced swing differential signal (RSDS)) enters the timing controller TCON 12. The image data is converted to an 8-bit digital (256 levels of gray) signal and sent to a look-up table (8-bit LUT) 14. The lookup table 14 stores 12-bit voltage values for each level of gray. The 12 bit voltage values corresponding to the image signal gray levels are streamed to the output registers 16 and de-MUX the serial data stream and send a full line of image data to the pulse shapers 17, 18, 19 and 20.

There is one pulse shaper 17, 18, 19 and 20 per display column starting with the left hand column of pixels N1 and ending with the extreme right hand column Ny. The ramp generator 22 generates an oscillating ramp 32, for example. The ramp voltage is determined by the voltage range desired for the pixel. For example, an LCD may have a ten volt swing from full black to full white. It is understood that any form of ramp can be used for the invention including sinusoidal, or saw toothed.

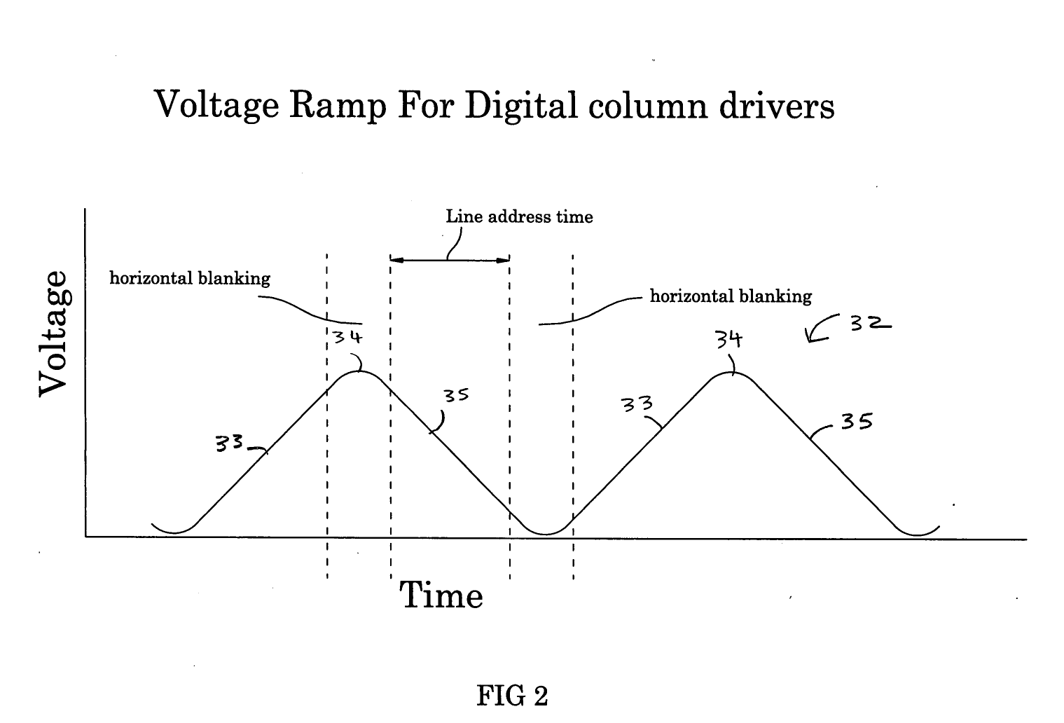

FIG. 2 illustrates an embodiment of the ramp signal 32. The voltage ramp 32 is generated by a 12 bit ramp function. The ramp 32 has a first linear region 33 with a positive slope and then a rounded region 34 where the slope changes from positive to negative and then a second linear region 35 with a negative slope. The purpose of the oscillating ramp 32 with the rounded peaks is to reduce the noise and harmonics. Saw toothed ramps create high levels of noise and high frequency harmonics leading to EMI problems due to the rapid voltage changes. As illustrated in FIG. 2, the linear region of the ramp signal 33 or 35 is the duration of the line address time and the rounded peaks 34 occur during the horizontal blanking time.

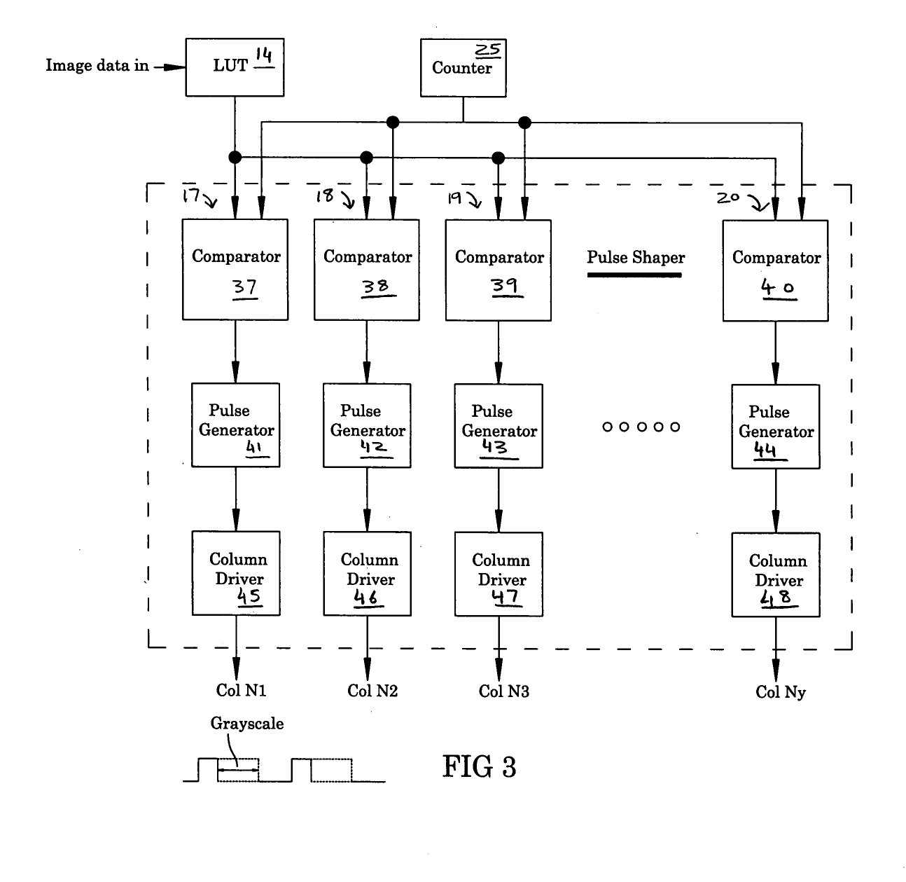

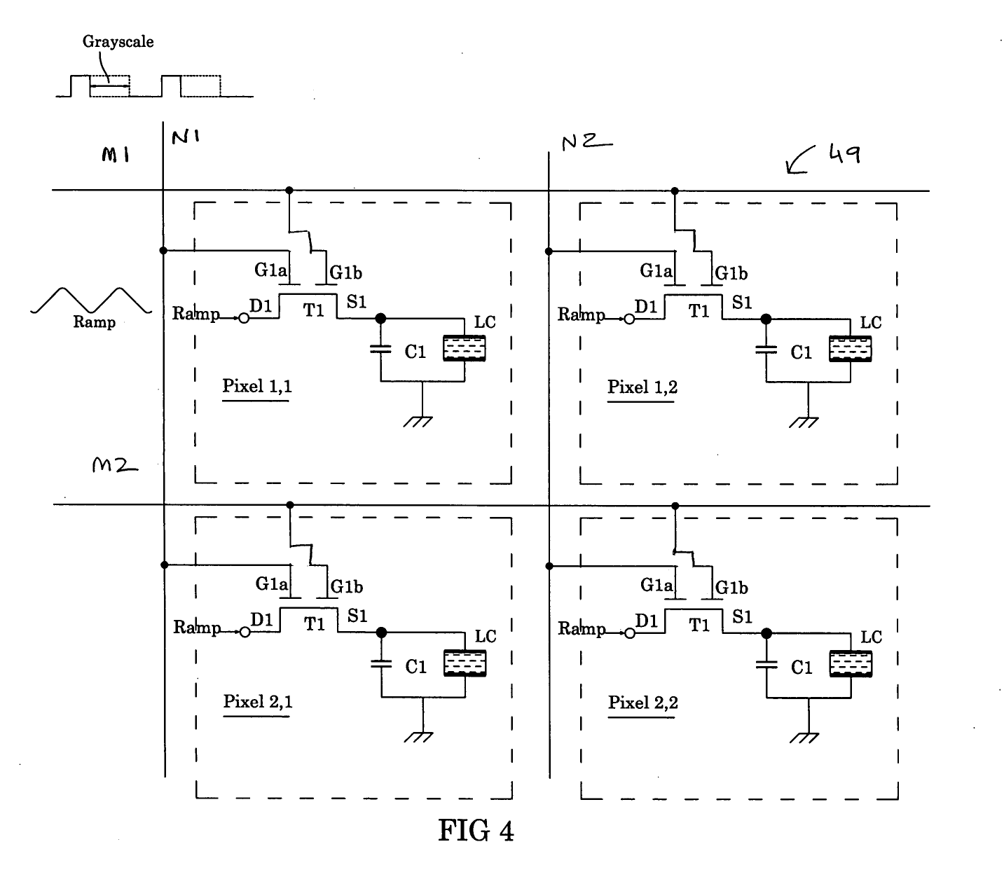

FIG. 3 is a detailed block diagram of an embodiment of the pulse shapers 17, 18, 19 and 20 that head up each column. The dashed line delimits the pulse shapers 17, 18, 19 and 20. The pulse shapers 17, 18, 19 and 20 form pulses of varying widths according to the digital value received from the LUT 14. The pulse generator 41, 42, 43 or 44 generates a pulse having a duration determined by the counter 25 and the digital value received from the LUT 14. The pulse is sent to the column driver 45, 46, 47 or 48 and is applied to the gate G1a of data TFT T1, as shown in FIG. 4.

FIG. 4 shows four pixels numbered 1,1, 1,2, 2,1, and 2,2 of a LCD display 49. The numbers stand for the row number Mx and the column number Ny respectively. Line M1 supplies a voltage to gate G1b when the first row is selected. The pulse from the pulse shaper 17, 18, 19 or 20 is applied to gate G1a. Simultaneously, the linear region of the ramp pulse 33 or 35 is applied to drain D1 of the T1. Since both gates G1a and G1b are high, the ramp voltage 32 is passed to the LCD cell LC and to the auxiliary storage capacitor C1. The amount of voltage transferred is determined by the width of the pulse on gate G1b.

It is understood that two switches (or transistors) can be used in place of TFT T1, which has two gates G1a and G1b. The reason for the two gates G1a and G1b is to minimize cross talk between adjacent pixels in a row (pixel 1,1 and pixel 1,2) when the column drivers 45, 46, 47 and 48 are driving pixels of the next and succeeding rows during the frame cycle. For example, when row M1 is deselected and row M2 is selected, gate G1b of pixel 1,1 goes low thereby trapping the voltage charge on C1 and across liquid crystal cell LC. Therefore, the global ramp 32 and the pulses applied by the column driver for column N1 will have no effect on the pixel 1,1 in the first row (M1) or in any row that is not selected. It is understood that any semiconductor material may be used to fabricate TFT T1 including but not limited to amorphous silicon, poly-silicon and cadmium selenide.

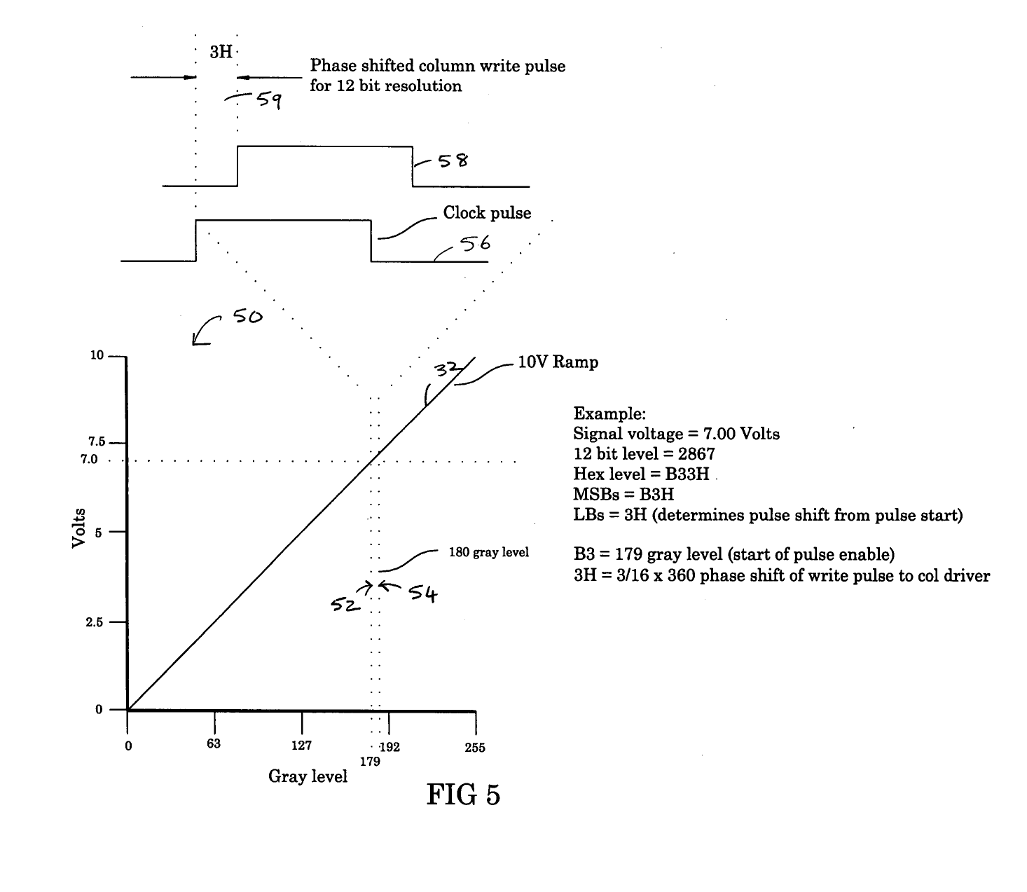

In one embodiment, the clock frequency for the pulse width system described above is required to be in the several hundred megahertz region and that can cause design problems especially over long distances in large displays. Therefore, in accordance with another embodiment of the present invention, a second method of pulse control of TFT T1 is the use of time position to place a column driver pulse on gate G1a of TFT T1 of FIG. 4. FIG. 5 gives the details of the pulse position method of the present invention. In this method, the pulse width is fixed and is called the aperture. The aperture width is set to give enough time for the ramp signal 32 to charge auxiliary storage capacitor C1. The value of the voltage placed on C1 is determined by the timing of the aperture pulse.

FIG. 5 gives an example of a 7.0 volt charge to be placed on C1. The 7.0 volts corresponds to an approximate gray level of 179 in a 10 volt system. The column driver pulse applied to G1a occurs when the ramp signal 32 is between the 179^{th} gray level 52 and the 180^{th} gray level 54. The clock pulse 56 goes high on the ramp signal 32 coincident with gray level 179, but the positional pulse 58 applied to the column line is shifted in phase by an amount of 3/16ths of one clock pulse or 67.5 degrees of phase shift.

In this example, the calculation is the following. The resolution is 12 bits and thus, on a 10 volt ramp 32, 7 volts is 12 bit level 2867. This number converts to hex level B33H. The 8 most significant bits (MSBs) are the hex number B3H, which when converted to decimal is 179. That is gray level 179. The 4 least significant bits (LSBs) are sent to a delay locked loop (DLL) 60 which selects the phase shift of the aperture pulse to give the exact 7.0 volts to a 12 bit resolution, but only uses a 25 MHz clock.

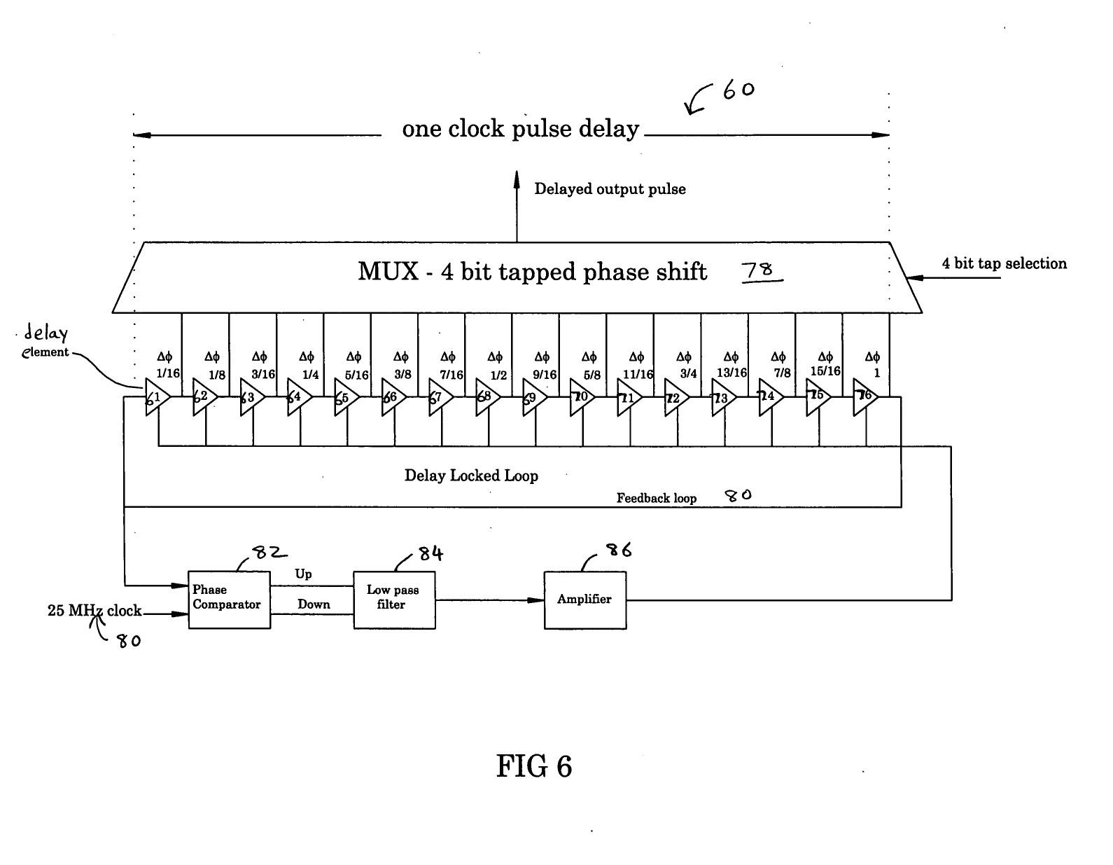

FIG. 6 illustrates how the DLL 60 works. The DLL 60 is a ring oscillator with a voltage controlled delay using a well known process called current starving. The delay elements are a series of inverters where each inverter delays the pulse a certain amount depending on available current to charge a capacitor. Therefore, the pulse is passed to the next inverter in the delay element depending on a certain voltage being attained on the capacitor.

To delay the pulse, or speed up the pulse, the current to the capacitor is changed. The number of inverters has to be even to keep the right pulse polarity and the number of inverter pairs determines how much of a phase shift each delay element contributes. The DLL 60 in FIG. 6 has 16 delay elements (61 through 76). Therefore, each element delays the pulse by 22.5 degrees. After each delay element is a tap running to the multiplexer (MUX) 78. The 4 bit LSBs from the LUT 14 are sent to the MUX 78 and select which tap will be out putted in the MUXed data stream sent to the column drivers 45, 46, 47 and 48. In this example, the LSB is 3H, which selects the 3^{rd} tap which has a delta phase shift of 3/16^{th} of 360 degrees or 67.5 degrees.

It is important that the DLL 60 delay the pulse by exactly 1 clock pulse. Therefore, the feedback loop 80 is connected to the first input of a phase comparator 82. The second input of the phase comparator 82 is connected to a 25 MHz clock signal 80. The output of the phase comparator 82 either increases the voltage (up) or decreases the voltage (down). Since the output of the phase comparator 82 is a short spike, it has to be filtered 84 and sent to an amplifier 86 which drives the delay element current control. This is analogous to a voltage controlled oscillator (VCO) in a phase locked loop. Therefore, the DLL 60 is locked to a one clock pulse delay.

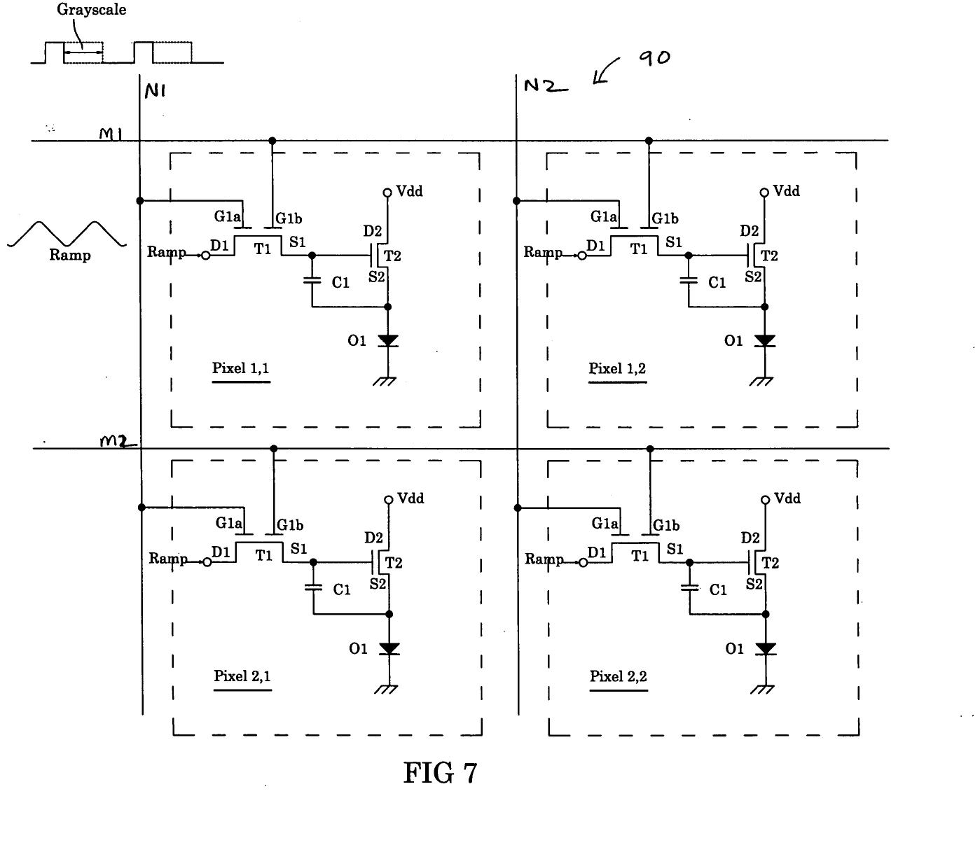

In another embodiment, the digital pulse drive of the present invention is applied to an emissive display such as an OLED display. It is understood that the two methods discussed above are applicable to emissive displays. FIG. 7 shows four pixels of an emissive display 90. It is understood that any emissive display driven by an analog voltage may be used including but not limited to LED displays, plasma displays (PDL), electroluminescent (EL) displays and organic light emitting displays (OLEDs).

The operation of the emissive display 90 is similar to the operation of the LCD 49 except that the ramp voltage 32 is applied to the gate of a current drive TFT T2 through T1. The added TFT T2 is necessary, because the light is generated inside the pixel by the, for example, OLED material O1, which requires a constant supply of current to maintain light emission during the frame time. This is accomplished by storing the data voltage on C1 in similar manner to the LCD case. It is understood that any semiconductor material may be used to fabricate TFTs T1 and T2, including but not limited to amorphous silicon, poly-silicon and cadmium selenide.

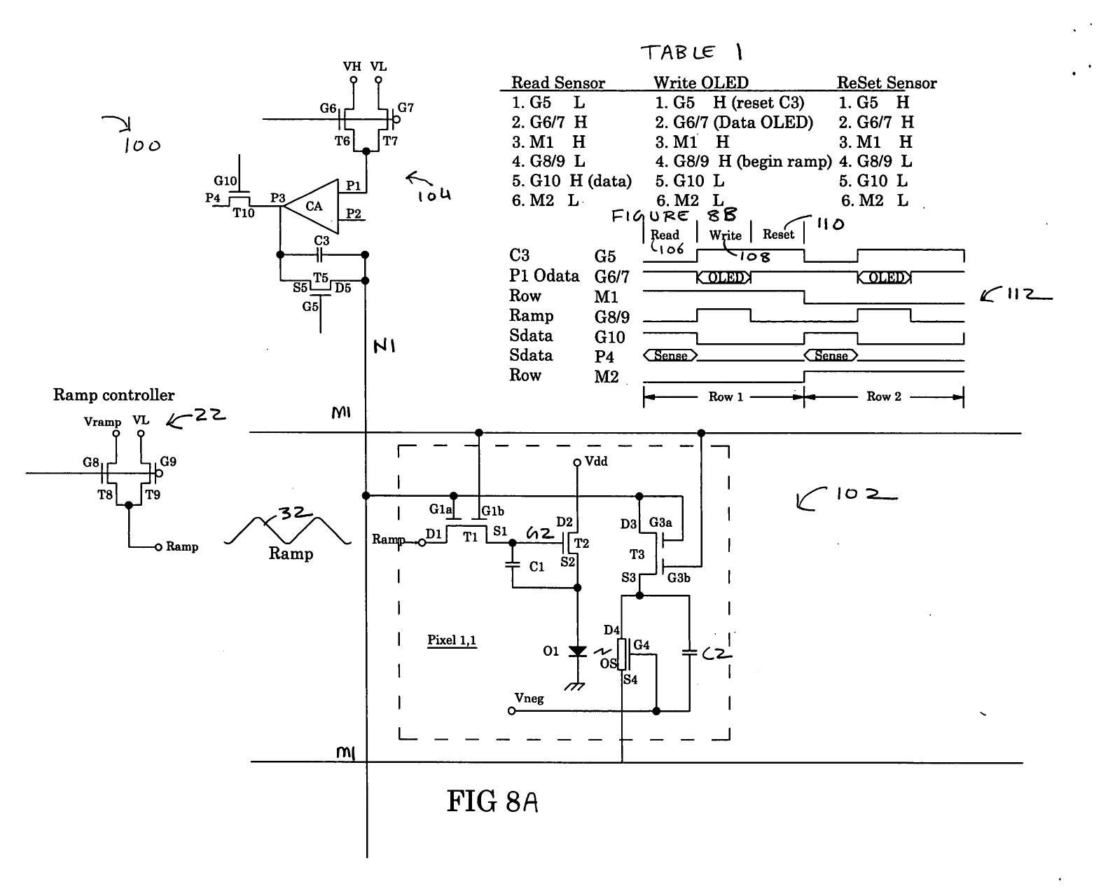

OLEDs have several serious drawbacks, which include short lifetime, differential color aging, image sticking and active matrix circuit parameter drift. These problems have all been addressed in several related patent applications mentioned at the beginning of this specification. FIG. 8A shows an OLED pixel 102 in an emissive feedback controlled system 100. The digital pulse drive system 100 of FIG. 8A has an advantage over the standard emissive feedback system, which is to eliminate the extra column line used to bring out the optical sense data developed in the pixel. In this embodiment, a digital drive system is used to write data to the OLED by pulsing open a window for the ramp generator to place a specific voltage on the OLED driver TFT T2 determined by the placement of the pulse window positioned in time.

The pixel circuitry includes the TFT T1 having the gates G1a and G1b, TFT T2 having the gate G2, the capacitor C1, the OLED O1, the TFT T3 having the gates G3a and G3b, the sensor OS having the gate G4 and the capacitor C2. The ramp controller 22 includes the TFT T8 having the gate G8 and the TFT T9 having the gate G9. The sensor readout circuit 104, which also provides the data pulse through the column line N1 to enable the gates G1a and G3a, includes the charge amplifier (CA), the TFT T6 having the gate G6, the TFT T7 having the gate G7, the field effect transistor (FET) T5 having the gate G5, the capacitor C3 and the field effect transistor (FET) T10 having the gate G10. The components are coupled as shown in FIG. 8A. One of ordinary skill in the art will understand the operation of the circuit shown in FIG. 8A.

This pulse data is carried by column line N1. Column line N1 is also used to carry the optical sense data. Table 1 shows the timing data for the operation of the circuit of FIG. 8A divided into three sections for clarity: a read section for reading out the optical sensor data, a write section for writing data to the gate of the OLED driver TFT T2, and a reset section for correcting charge imbalance on capacitors C3 and C2 due to the OLED data on the column line. FIG. 8B illustrates a timing diagram 112 for the illustrating operation of the circuit shown in FIG. 8A as shown in Table 1. It is understood that the timing data and the method for reading the sensor OS and writing to the OLED driver TFT T2 are exemplary and that there are other equivalent methods and circuitry known in the industry.

During the sensor read portion 106 of the timeline 112 of FIG. 8B, the components of the system 100 operate in the following manner. G5 is the gate of the field effect transistor (FET) T5, which is used to reset the charge amp (CA) capacitor C3. During this time 106 G5 is low, thereby enabling CA to read the sensor data. Gates G6 and G7 of transistors T6 and T7, respectively, control the voltage on node P1, which is high during the sensor reading. Line M1 is high. That selects the first row of pixels and activates gates G1b and G3b, which is necessary but not sufficient to allow data to be read from the sensor OS or data to be written to the OLED driver TFT T2.

Gates G8 and G9 of transistors T8 and T9, respectively, of the ramp controller 22 are low. That prevents the ramp voltage 32 from being transferred to TFT T2 during the sensor read period. Gate G10 of the FET 10 is high, thus enabling charge amp CA to be read. P4 is the node where the sense data from charge amp CA appear. M2 is the select row line for row 2 and is low during the address time for row 1 or for any other row not being addressed.

During the data write portion 108 of the timeline 112 of FIG. 8B, the components of the system 100 operate in the following manner. G5 is the gate of FET T5 and is high. That shorts nodes P3 and P2, and therefore, facilitates the control of the voltage on node P1 over column line N1. Gates G6 and G7 control the voltage on node P1 which is connected either to a high reference voltage for charge amp CA or to the pulse generator which delivers the data information to place a section of the ramp voltage on gate G2 of the OLED driver TFT T2. The gates G6 and G7 initially go low, thus isolating the ramp voltage from C1 and G2. The pulse generator then determines when and for how long gate G1b will be high, and thus, how much voltage is transferred from the ramp to C1 and G2.

It is understood that the column pulse affects the gate G3a and drain D3 of the TFT T3, which in turn will affect the voltage on the sense capacitor C2. This is noise on the sensor and will be erased during the reset section. M1 is high selecting the first row of pixels and activates gates G1b and G3b, which is necessary but not sufficient to allow data to be read from the sensor OS or data to be written to the OLED driver TFT T2. Gates G8 and G9 of the ramp controller 22 are high, thus turning on the ramp 32. G10 of FET T10 is low, thus turning off sense data. P4 has no data on it. M2 is the select row line for row 2 and is low during the address time for row 1 or for any other row not being addressed.

During the reset portion 110 of the timeline 112 of FIG. 8B, the components of the system 100 operate in the following manner. G5 is the gate of FET T5 stays high to maintain sensor voltage on column line. G6 and G7 go high to supply sensor voltage. M1 is high selecting the first row of pixels and activates gates G1b and G3b which is necessary but not sufficient to allow data to be read from the sensor OS or data to be written to the OLED driver TFT T2. Gates G8 and G9 go low, thus preventing the ramp voltage from being transferred during the interval. That also locks the data voltage on C1 and G2 while T1 is open during the resetting of the sensor. G10 of FET T1 is low, thus turning off sense data. P4 has no data on it. M2 is the select row line for row 2 and is low during the address time for row 1 or for any other row not being addressed.

After the address time for row one is completed M1 is deselected, thus isolating the sensor circuit composed of sensor OS and sensor capacitor C2. Sensor OS now begins to discharge capacitor C2 to the next row line, which is grounded for most of the frame time. The amount of charge drained from C2 depends on the luminance of OLED O1. When all the lines are addressed and the frame is completed, M1 will be reselected and the amount of discharge of C2 will be read out by charge amp CA. As soon as M1 is deselected, M2 is selected and the address process for row 2 repeats identically with that of row 1. The only exception is that M1 is low and M2 is high.

1. A flat panel display comprising:
a matrix of pixels;
a signal generator for generating a ramp signal;
a column driver for driving a column of pixels;
a row driver for driving a row of pixels; and
a pixel control circuit; wherein,
the pixel control circuit for selectively applying the ramp signal a pixel driven by the row driver and the column driver to illuminate the pixel.

2. The flat panel display of claim 1, wherein the flat panel display includes a liquid crystal display having a matrix of liquid crystal cells.

3. The flat display of claim 1, wherein the flat panel display includes an organic light emitting diode display having a matrix of organic light emitting diodes.

4. The flat panel display of claim 1, wherein the flat panel display includes a light emitting diode display having a matrix of light emitting diodes.

5. The flat panel display of claim 1, wherein the pixel control circuit for applying the ramp signal to the pixel for a selected amount of time.

6. The flat panel display of claim 1, wherein the pixel control circuit for applying the ramp signal to the pixel for a selected amount of time based on the gray scale level requirement for the pixel.

7. The flat panel display of claim 1, wherein the pixel control circuit for applying a selected portion of the ramp signal to the pixel.

8. The flat panel display of claim 1, wherein the pixel control circuit for applying a selected portion of the ramp signal to the pixel based on the gray scale level requirement for the pixel.

9. The flat panel display of claim 1, further comprising:
a feedback circuit for measuring the luminosity of the pixel.

10. The flat panel display of claim 9, wherein the feedback circuit including a sensor embedded in the pixel.

11. The flat panel display of claim 1, wherein the signal generator for generating a voltage ramp signal.

12. A method for a flat panel display comprising:
generating a ramp signal;
selecting a pixel from a matrix of pixels; and
selectively applying the ramp signal to the pixel to illuminate the pixel.

13. The method of claim 12, wherein applying the ramp signal to the selected pixel for a selected amount of time to illuminate the pixel.

14. The method of claim 12, wherein applying a selected portion of the ramp signal to the selected pixel to illuminate the pixel.

15. The method of claim 12, wherein selectively applying the signal to the pixel to illuminate the pixel based on the gray level requirement for the pixel.

16. The method of claim 12, wherein generating a ramp signal including generating a voltage ramp signal.

17. The method of claim 12, further comprising:
receiving a feedback signal from the pixel indicative of the luminosity of the pixel.

18. A flat panel display comprising:
a pixel including a thin film transistor;
the thin film transistor including a first gate and a second gate;
a ramp generator coupled to the drain of the thin film transistor;
a column driver coupled to the first gate to selectively enable the first gate; and
a row driver coupled to the second gate to selectively enable the second gate; wherein
the source of the thin film transistor provides the ramp signal generated by the ramp generator when both the first gate and the second gate are enabled.

19. The flat panel display of claim 18, wherein the flat panel display includes a liquid crystal display including a matrix of liquid crystals.

20. The flat panel display of claim 18, wherein the flat panel display includes a organic light emitting diode display including a matrix of organic light emitting diodes.
